(19) United States
(12) Patent Application Publication
(10) Pub. No.: US 2018/0005294 A1
(43) Pub. Date: Jan. 4, 2018

(54) PRODUCT IDENTIFICATION BASED ON IMAGE MATCHING

(71) Applicant: Chrissey Hunt, Westport, CT (US)

(72) Inventor: Chrissey Hunt, Westport, CT (US)

(21) Appl. No.: 15/199,383

(22) Filed: Jun. 30, 2016

(51) Int. Cl. G06Q 30/06

(52) U.S. Cl. CPC G06Q 30/0627; G06Q 30/0643; G06Q 30/0603; G06Q 30/0619

(57) ABSTRACT

Shoppers may access images and “box” or “outline” particular objects in the image. The outlined object may be used to search for the product. The product may be identified in a database of products through image recognition and/or the assistance of community members. When a product match is identified, the shopper may be presented with a link or other purchase information to acquire the desired product. When community assistance is used, the image of the requested product may be published to the community, where members who are familiar with the product may identify the requested product and offer the product for sale or provide a referral to a seller.

### FIELD OF THE DISCLOSURE

The instant disclosure relates to computer systems. More specifically, portions of this disclosure relate to image identification by computer systems.

### BACKGROUND

Consumers are accustomed to searching online for items they wish to purchase. Although many options are available, conventionally, a consumer may search using one of two methods. Some consumers may go online to a search engine and type in words that are associated in their minds with the item they want to purchase. Other consumers may go to a specific website and type in words associated in their minds with the item they want to purchase. Both methods often fail to generate a result that matches the item the consumer wants to purchase. There may be many causes for this failure.

One cause for the failure is that with the growth of the Internet more sellers are posting online. Hundreds of thousands of images can be displayed on the screen, resulting in hours of endless searching and obvious frustration. A search for a “wood table” on one site produced nearly one million results. This large number of results creates information overload and results in a very low percentage of consumers finding what they wanted to purchase. In fact, many users may give-up finding what they are looking for completely, resulting in lost sales.

Another cause for the purchase failure may be the number of different websites. Not only do individual websites include thousands or even a million possible matches to common keyword searches, but there are tens or hundreds of potential sites to search. There are multiple auction marketplaces and multiple traditional and not-traditional vendors of goods running different websites. There is currently no way to search all websites to compare similar or equal items for sale at the same time. In the end, the failure to identify the product the consumer desires results in an unsatisfied consumer and sellers missing out on a potential sale.

### SUMMARY

A user may identify the product they want to purchase through images, rather than words. Images often portray more detail regarding a requested product and allow for a more accurate match to be identified for the requested product. Thus, an image may be used, in part, to identify the product the user wishes to purchase. The image may be compared to a database of images to determine matching products. For example, a bot may receive the image and use image processing algorithms to identify matching products from a database of products known to be offered for sale. When one or more matching products are identified, the user may be presented with the results, along with a link for purchasing the matching products. The link may be, for example, a universal resource locator (URL) for identifying a web page on the Internet, an address with driving directions to a store with location information for where to locate the matched product in the store, and/or a telephone number, e-mail address, social media account, or other contact information for contacting a seller of the matched product. Alerts, such as by email message or text message, may also be set up to allow a user to receive a notification when a new matching product is identified.

The database of matching products may be created by other users, such as other shoppers, merchandisers, and community members. For example, merchandisers may upload information into the database regarding products they offer for sale, including images of their products, and links for purchasing their products. As another example, shoppers may upload images of products, such as by taking photographs with their mobile devices and/or uploading scans of pictures or catalog pages. The shoppers may eventually identify or have identified the product image, and the database may be updated to include the discovered information about the initially-unknown product. As a further example, community members may assist in adding information to the database, including images of products and links to purchase those products. The community members may be encouraged to assist through revenue sharing or other rewards programs. Further, owners of copyrighted images may be made partners and capitalize on the use of their images by receiving a listing fee per user. Community members may upload images, product information, and sale offers for products they have, can acquire, or can build. In addition to uploading information into the database of products, any user may search for open requests from potential buyers to assist with identifying products. For example, buyers may post images of a product they want to purchase, and other users, such as other shoppers, merchandisers, or community members may match products they add to the database of products to the buyer's requested product.

The database of matching products may also or alternatively be created by a crawler. For example, a server, which may or may not be the server hosting the database, may crawl through web pages of individuals or stores selling products. While crawling, the server may fetch and store images, text on the web page that accompanies the images, and links to the pages containing the product information. This information may be stored in the database and periodically or occasionally updated by revisiting the web pages or identifying new web pages containing additional or replacement product information.

The image of the requested product may also or alternatively be published to a community of members who may be able to identify the product. Members in the community may view product images identified by a potential purchaser. When a member identifies the product in the image, the member may provide information regarding the product, including a link to purchase the product. Separate from the community manually adding information to the database of products, the community may be asked to help identify a specifically-requested product. The community may view images of these unknown or unidentifiable products and then provide information regarding the products, such as a link to an offer to sell the product. The offer to sell the product may be an offer to sell by the community members or may refer the buyer to a retailer or other third party.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an example user interface illustrating the display of products according one embodiment of the disclosure.

FIG. 2 is an example user interface illustrating the display of information regarding a product in a pop-up informational box according to one embodiment of the disclosure.

FIG. 3 is an example user interface illustrating the receipt of additional search information regarding a requested product according to one embodiment of the disclosure.

FIG. 4 is an example user interface illustrating the display of matched products according to one embodiment of the disclosure.

FIG. 5 is a flow chart illustrating an example operation for a server operating a user interface according to one embodiment of the disclosure.

FIG. 6A is a flow chart illustrating an example operation for a server for matching requested products using a database of images according to one embodiment of the disclosure.

FIG. 6B is a flow chart illustrating an example operation for a server for matching requested products using a community of members according to one embodiment of the disclosure.

FIG. 7 is an example system for receiving product requests and matching products to the requests according to one embodiment of the disclosure.

FIG. 8 is an example user interface illustrating the display of pinned images according to one embodiment of the disclosure.

FIG. 9 is an example user interface illustrating an application for interacting with web pages to save images and identify products according to one embodiment of the disclosure.

### DETAILED DESCRIPTION

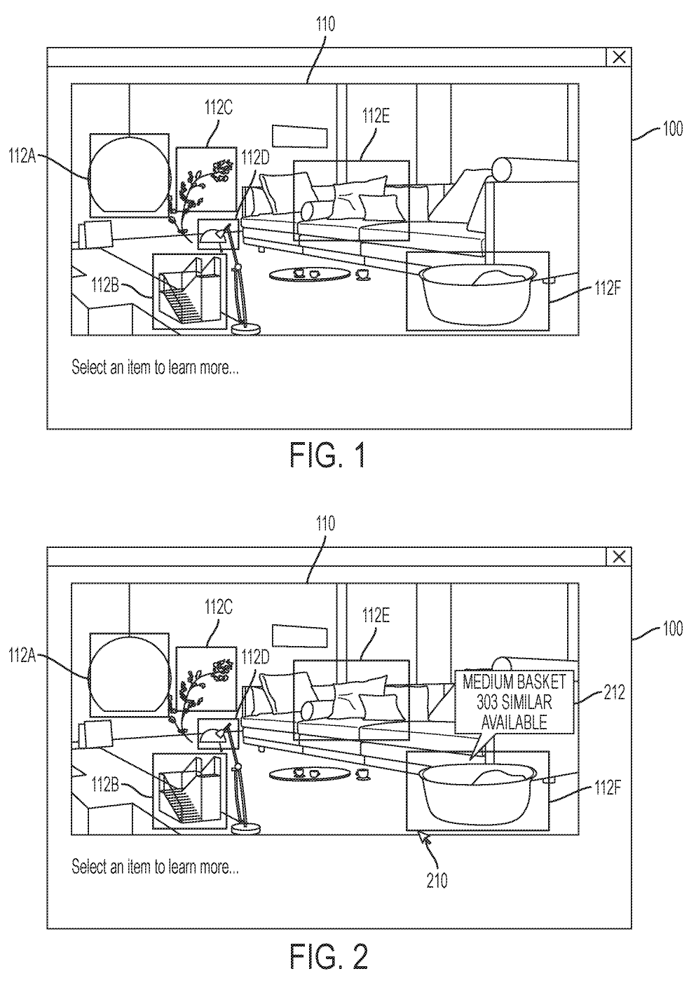

FIG. 1 is an example user interface illustrating the display of products according one embodiment of the disclosure. A user interface 100 may be displayed on a personal computer (PC), tablet, mobile phone, or other computing device. The interface 100 may display an image 110 containing one or more potential products 112A-F. The image 110 may be a picture obtained from a user, such as by uploading the image to a server. The uploaded image may be taken by the user with a camera, such as a camera integrated with a mobile device, when the user sees a product they would like to purchase. The image 110 may alternatively be a picture taken by the user from other sources, such as by taking a picture of a catalog or other printed material illustrating the desired product. The image 110 may alternatively be one of many images already stored on the server that a user may browse to search for desired products.

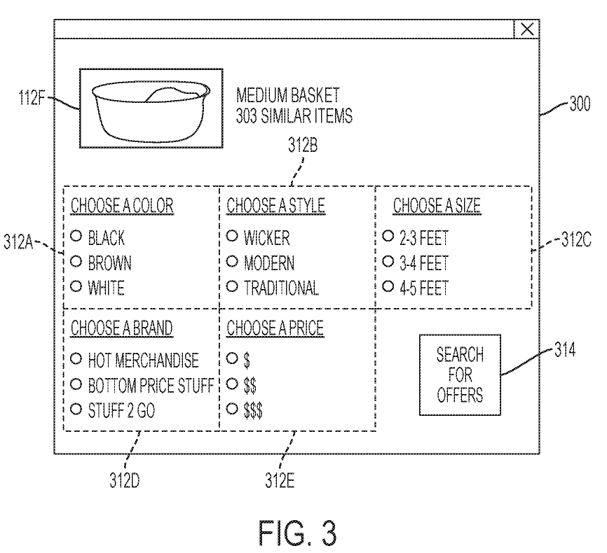

The user may interact with the image 110 of the interface 100 to make a request for a particular product of the potential products 112A-F in the image 110. For example, FIG. 2 shows the display of information regarding a product according to one embodiment of the disclosure. A user may move a cursor 210 around the image 110, or otherwise interact with a computing device to cause similar effects, such as by hovering a finger over a particular portion of a display or touching a particular location of a touch screen display. As the cursor 210 is moved across the image 110, boxes may highlight particular regions of the image where the potential products 112A-F have been identified. Further, as the cursor 210 is moved across the potential products 112A-F, an informational box 212 may pop-up to provide some available information regarding the potential products 112A-F. For example, the informational box 212 may include a generic description of the potential product and an indication as to how many of that potential product or how many items similar to the potential product are available for sale. The user may select one of these regions using the cursor 210 to select one of the potential products 112A-F as a requested product.

In some embodiments, the informational box 212 may include other information or options. For example, the box 212 may include a buy option button that directs the user to the closest matching product to purchase or to a page of matching products and offers to sale by various sellers. As another example, the box 212 may include a sell option button that directs the user to a page to offer their own matching product for sale. The user may then create a listing and link the listing to the selected product. As a further example, the box 212 may include a refer option button that directs the user to page to enter product information and a referral link to a retailer or other seller that offers the product for sale. As yet another example, the box 212 may include a like option button that bookmarks the product for future reference.

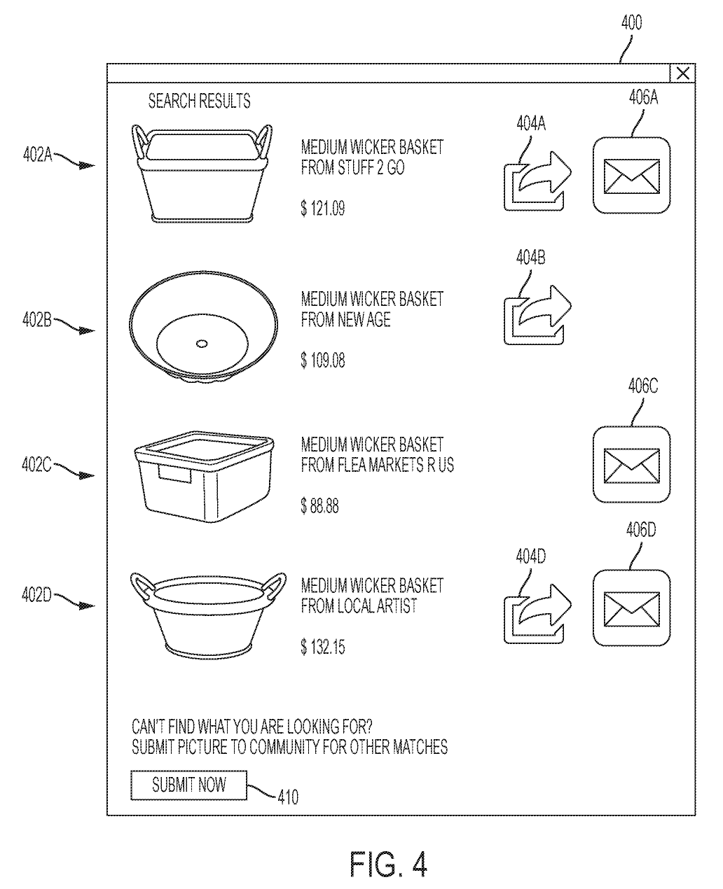

After selecting one of the potential products 112A-F, the user may be directed to an interface for receiving additional specifications describing the requested product. FIG. 3 is an example user interface illustrating the receipt of additional search information regarding a requested product according to one embodiment of the disclosure. A user interface 300 may display a selected potential product 112F selected by the user with the cursor 210 and one or more user specifications 312A-E to assist in defining a matching product. For example, a user may specify a color in specification 312A, a style in specification 312B, a size in specification 312C, a brand in specification 312D, and/or a price in specification 312E. Some, all, or other specifications may be included in the user specifications 312A-E. Options in the specifications 312A-E may be selected based on information in the image regarding the requested product 112F. For example, the server may identify that the requested product 112F is a dark color and thus only present the black and brown options in color specification 312A. After the user has provided one or more specifications 312A-E for the requested product 112F, the user may select a submit button 314 to begin the search for matching products. A server receives the image of the requested product 112F and the one or more specifications 312A-E when the button 314 is pressed. For example, pressing the button 314 may execute a POST or GET HTTP operation to submit the information, including an indication of the requested product 112F and the one or more specifications 312A-E, to the server. Although specific examples of formats and methods are provided for transmitting information to the server, operation of different embodiments of the invention may involve other data transfer techniques and timings. The server may process the submitted information to search a database of products for matching products. The search may be performed nearly instantaneously by an algorithm, such as a bot. The search may also or alternatively be performed by requesting community members to identify the product and alerting the user when matching products are identified by the community members.

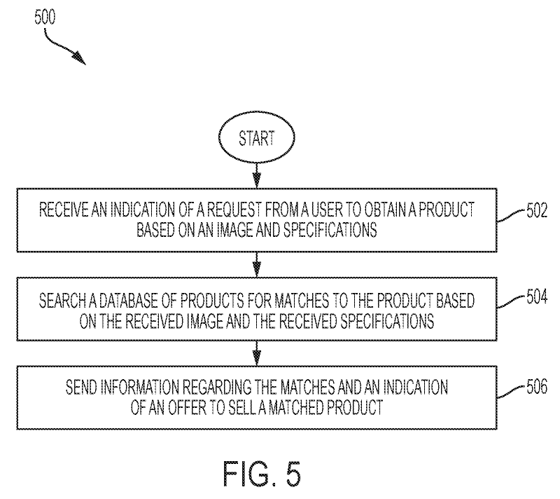

After the search is complete, a list of matching products, which may be similar matches or exact matches, may be displayed to the user. FIG. 4 is an example user interface illustrating the display of matched products according to one embodiment of the disclosure. A user interface 400 may include search results 402A-D. Some of the search results 402A-D may be accompanied by offers to sell the matched product, such as offers from an individual or a retail store. Links 404A-D may be provided for some of the respective results 402A-D. A user may click the links 404A-D to be taken to a web page to purchase the matched product, or otherwise provided with information for purchasing the matched product. Further, contact information 406A-D may accompany the matched products, to allow a user may request further information regarding the matched product. The contact information 406A-D may include, for example, an e-mail address, a telephone number, an address, or a social media account handle.

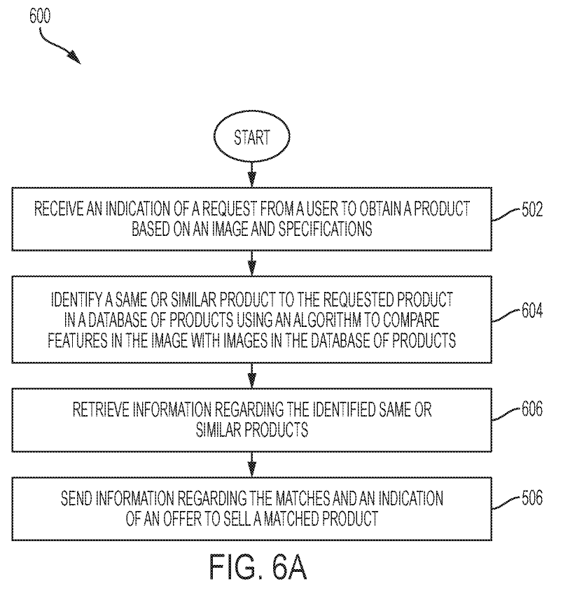

A server may perform functions that facilitate the receiving and transmission of data to support user interfaces described above. One method that may be operated by a server for identifying products is described with reference to the flow chart of FIG. 5. FIG. 5 is a flow chart illustrating an example operation for a server operating a user interface according to one embodiment of the disclosure. A method 500 may begin at block 502 with receiving an indication of a request from a user to obtain a product based on an image and specifications. The indication may be received from a client computing system displaying the user interfaces of FIG. 1, FIG. 2, FIG. 3, and FIG. 4. The indication may be assembled, for example, by receiving a product image selected from potential products 112A-f in the user interface 100 of FIG. 1 and receiving one or more specifications from specifications 312A-E of FIG. 3. The client computer may send to the server the indication as a URL containing a web page address combined with parameters specifying the product image and the one or more specifications. Other methods of transmitting the indication are also possible, and the URL technique described here is not intended to limit the operation of the server or the execution of the step in block 502.

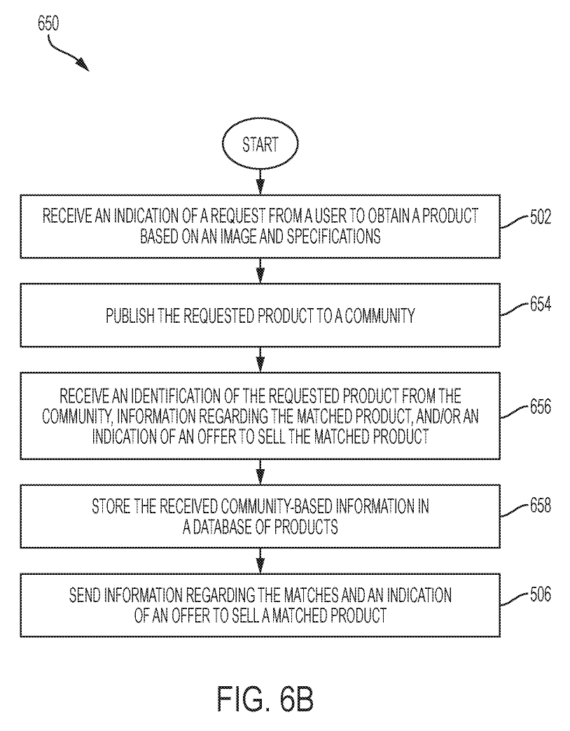

After the indication is received by a server at block 502, the method 500 may continue to block 504 at which the server may search a database of products for matches to the product based on the image and the one or more specifications. The server may search a database by using image processing algorithms that examine features within the received image of the requested product and compare those features with features in images of products in the database of products. Similar or exact matching products may be identified from the database using the image comparison, and a better match obtained by using the one or more specifications. For example, image analysis may select twenty similar products from the database of products, and the one or more specifications applied to further reduce the matching products to four products. Additional details regarding searching using image analysis is described below with reference to FIG. 6A. The server may also or alternatively search a database by using other users to identify matching products. The requested product image may be published for community members to view. The community members may be able to match the requested product to a product already in the database of products. The community members may alternatively add a new product to the database of products and indicate the new product matches the requested product. Additional details regarding searching using community members is described below with reference to FIG. 6B.

After one or more matching products are identified at block 504, the method 500 may continue to block 506 to send information regarding the matches to the client computer. The server may transmit a list of matching products for display on a user interface. For example, the server may assemble a web page containing the matching products into a hypertext markup language (HTML) document that is transmitted to the client computer through the hypertext transfer protocol (HTTP). As another example, the server may assemble an email message containing the matching products into plain text or hypertext markup language (HTML) document that is transmitted through a simple mail transfer protocol (SMTP) to one or more recipients, including the user that transmitted the request that was received at block 502. Although web pages and other specifically-formatted documents are described above, the operation of method 500 may include receipt and transmission of data in any format. For example, an application programming interface (API) may be available on the server to receive and transmit information to applications executing on a mobile device, such as a mobile phone or tablet.

The list of matching products may also include information regarding the products, an image of the products, and/or an indication of an offer to sell a matched product. When a product is known to be sold by a particular retailer, a link or other contact information may be included with the list of products to inform a user of the offer to sell by the retailer. When a product is known to be sold by an individual, a link or other contact information may be included with the list of products to inform a user of the offer to sell by the individual. When a product is known to be sold through an auction site, a link or other contact information for the auction may be included with the list of products. Thus, after a user receives the list of matched products, the user may know which are available for purchase and then complete a transaction to acquire one or more of the matched products.

Referral fees and/or commissions may be collected when sales are made based on the matches reported at block 506. For example, a referral fee may be paid by a retailer to the operator of the server when a user is referred to the retailer to complete the purchase. As another example, a commission may be paid by an individual seller to the operator of the server for facilitating the identification of the matched product to the requested product. In some embodiments, the transaction may be completed through the server, such that a commission may be collected from the buyer's payment and the remainder passed on to the seller. In other embodiments, the transaction may be completed by a third party and the seller billed separately for a percentage of the sell by the operator of the server. Community members who assist in the matching of products at block 504 may receive a part of the commission paid to the operator of the server, or the community members may be provided with other reward or incentive programs.

As described above, one manner for searching a database of products may include image processing or other algorithms for matching features in images. FIG. 6A is a flow chart illustrating an example operation for a server for matching requested products using a database of images according to one embodiment of the disclosure. A method 600 may include receiving an indication of a request from a user to obtain a product based on an image and specifications at block 502, as with the method 500 of FIG. 5. Then, at block 604, a same or similar product as the requested product may be identified from a database of products using an algorithm to compare features in the image of the requested product with images in the database of products. Next, at block 606, information regarding the matched products of block 604 may be retrieved, such as from the database of products or other sources. The list of matched products and retrieved information may then be sent to a client computer at block 506.

Another manner for searching a database of products may include obtaining community members assistance in matching products to requested products. FIG. 6B is a flow chart illustrating an example operation for a server for matching requested products using a community of members according to one embodiment of the disclosure. A method 650 may include receiving an indication of a request from a user to obtain a product based on an image and specifications at block 502, as with the method 500 of FIG. 5. Then, at block 654, the requested product and/or specifications may be published to a community for assistance in identifying the requested product. At block 656, the server may receive an identification for the requested product from the community, information regarding the matched product, and/or information regarding how to purchase the matched product. Next, at block 658, the community-based information may be stored in the database of products. In some embodiments, the received product from the community may be verified prior to storage in the database of products, such as by applying an image processing algorithm to ensure the community-based information reaches a desired level of certainty of a product match. Then, the list of matched products and retrieved information may be sent to a client computer at block 506.

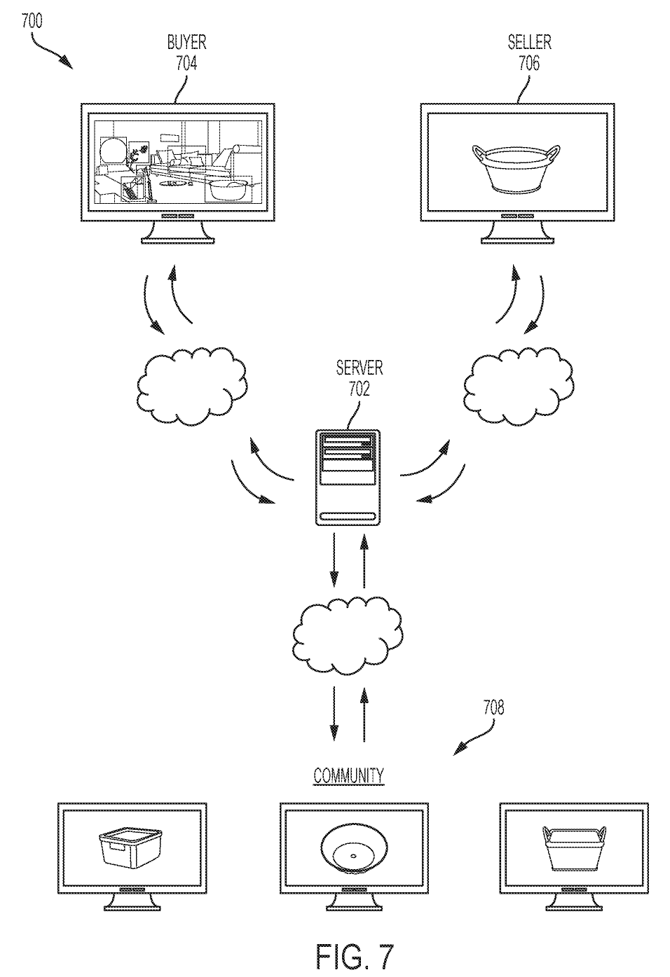

One system for facilitating the identification of products described above is shown in FIG. 7. FIG. 7 is an example system for receiving product requests and matching products to the requests according to one embodiment of the disclosure. A system 700 may include a server 702 in communication with several clients through a network, such as the Internet, through either wired or wireless communications. The server 702 may include software, firmware, or hardware configured to execute operations described above, such as those described in the methods of FIG. 5, FIG. 6A, and FIG. 6B. The server 702 may communicate with a client computer 704 accessible by a potential buyer. The buyer's client computer 704 may display user interfaces, such as those illustrated in FIG. 1, FIG. 2, FIG. 3, and FIG. 4. The server 702 may also communicate with a client computer 706 accessible by a seller. The seller's client computer 706 may display user interfaces to allow retailers, auctioneers, and/or individuals to enter products into the database of products. The server 702 may also communicate with a client computer 708 accessible by community members. The community's client computers 708 may display user interfaces to allow community members to identify products requested through the buyer's client computer 704 and/or enter products into the database of products.

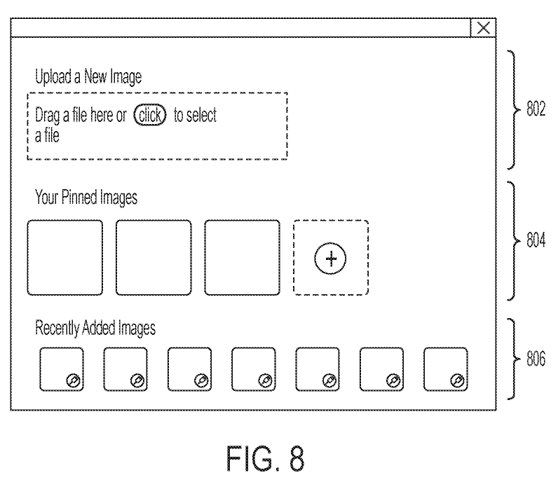

Images used for boxing and identifying products may be uploaded and saved through a web or mobile interface. One example web interface is shown in FIG. 8. FIG. 8 is an example user interface illustrating the display of pinned images according to one embodiment of the disclosure. A home screen for a user may present an option of uploading an image file through controls 802, viewing previously saved or “pinned” images through controls 804, and viewing recently added images by others through controls 806. Images shown in controls 806 may include images that have been uploaded from different users. After a user uploads an image, such as through controls 802, the user can pin the image, which may designate a particular image as a master image to reduce a number of multiple images floating around uploaded by different users. In one embodiment, when images are uploaded through controls 802, the server or client may check for duplicates of the uploaded image and merge records in a database for matching images. Removing duplicate images may reduce resources consumed by the server computer and reduce the number of product identifications and matches that need to be made, because the uploader of the duplicate image can be referred to the original version of the image, which may already have identified products and offers for sale.

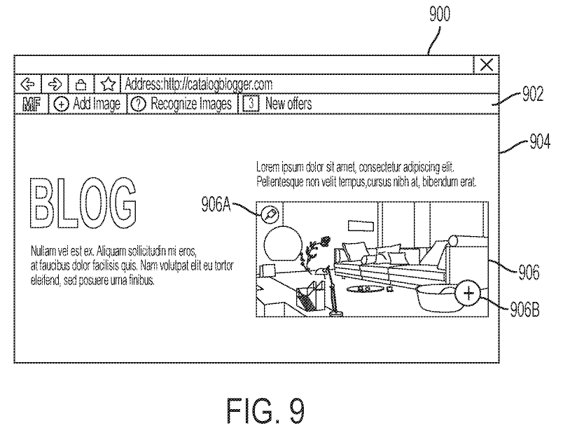

Images may also be saved from other interfaces through an application, such as a mobile application or a plug-in for a web browser. FIG. 9 is an example user interface illustrating an application for interacting with web pages to save images and identify products according to one embodiment of the disclosure. A user interface 900 may be, for example a web browser, that loads and displays web pages from various sites on the Internet, sites that may be unrelated to the web server providing the product identification functionality described above. The user interface 900 may include, for example, a plug-in 902 that can perform actions on images appearing on web pages that are loaded in the user interface 900. For example, when a blog 904 is loaded, an image 906 may be identified on the web page and content overlaid on the image 906. An add icon 906B may be overlaid on the image 906, which allows a user to use one click to upload the image 906 to the server computer where products within the image may be matched to a database of products or a community requested to identify products in the image. If the blog 904 loads and the image 906 is determined to already have been uploaded to the server computer, either by the current user or another user, a pin icon 906A may be overlaid on the image 906, which allows a user to select the image for pinning to a home screen such as to appear in controls 804 of FIG. 8. The functionality described with reference to FIG. 9 may be obtained through other applications, such as in applications on a mobile phone. For example, a mobile application may be installed on a mobile device that integrates with the “Share to” menu of the mobile phone operating system. Thus, a user may load a photo, either saved from the Internet or taken with their camera, and then “share” the photo to the mobile application, where the mobile application can identify the image as previously uploaded or upload the image as a new image. In some embodiments, the plug-in or mobile application may also overlay icons indicating offers to sale products identified in the image.

Embodiments of the invention described above allow a potential customer to identify and purchase items using product images, which improves the likelihood of the customer finding the desired product or a similar product and thus increases the rate of sales of the products and customer satisfaction. In these embodiments, the potential consumer sees the item they desire, such as in part of an image in a publication (e.g., a magazine, catalogue, photo, etc.), and can use the image to identify matching products for purchase. Such an operation improves the conventional manner for finding products, where the consumer sees the item, likes the item, but may have difficulty searching for the item they wish to purchase because there is no link or other information to match the consumer with the seller of the item. The consumer would conventionally resort to searching for the item using an Internet search engine or searching an individual site, such as online auction sites or internet retailers. The search could take a long time, and many times the search is fruitless and frustrating: results are not exact or not similar to the item in the original image. The consumer is relying on their own words to describe the item, and they are relying on the search engine to interpret those words. Sometimes, the consumer doesn't know that the item is a 1950's sconce from a particular manufacturer, and thus the consumer is unable to search for an item without knowing the origin.

Embodiments of the invention provide the consumer, seller, and other users the ability to “box” or “outline” the exact object on an image, create a listing with specific parameters, and allow both parties to contact each other. Information may be supplied by the consumer (e.g., quantity, dimensions, material of fabrication, price range, etc.) and that information used to search products and/or request assistance from community members in locating the item. A seller of the item will then be able to see that there is a need for their product, the seller may contact the consumer, and a sale will be generated. Hours of searching may be reduced to a quick efficient sale, and a happy customer.

A user of embodiments of this invention may be able to identify an item or service that they desire. Further, users may sell an item or service, or refer an item or service that someone may be trying to find. A community of buyers and sellers of goods and services may be provided communication with each other quickly, whereas conventional sales channels would not be able to connect the buyers and sellers.

The schematic flow chart diagrams of FIG. 5, FIG. 6A, and FIG. 6B are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processing of product images is described, other data may be processed through similar databases and workflows as those described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
receiving, at a server computer, an indication generated by a client computer of a request from a user to obtain a product based, at least in part, on an image and one or more specifications;
searching, by the server computer, a database of products for matches to the requested product based, at least in part, on the received image and the received one or more specifications; and
sending, by the server computer to the client computer, information regarding the matches to the product, wherein the information includes at least one identification of an offer to sell the matched product.

2. The method of claim 1, wherein the step of searching for matches comprises:
identifying, by the server computer, a same or similar image in the database of products based on the received image; and
retrieving, by the server computer, the information from the database based on the identified same or similar image.

3. The method of claim 1, wherein the step of searching for matches comprises:
receiving, by the server computer from a second client computer, an identification of a matched product from a community member and information regarding the matched product, wherein the information regarding the matched product comprises a link to an offer to sell the matched product; and
storing, by the server computer in the database of products, the identification of the matched product and the information regarding the matched product.

4. The method of claim 1, wherein the step of searching for matches comprises executing a software algorithm to identify a matched product by comparing the received image with the database of products.

5. The method of claim 1, further comprising:
crawling, by the server computer, webpages of product manufacturers, wherein the webpages comprise product images;
inserting, by the server computer, the product images into the database of products; and
inserting, by the server computer, links to the webpages comprising the inserted product images into the database of products, wherein the links are associated with the product images in the database of products,
wherein the step of sending information regarding the matches to the product comprises sending a link to a webpage crawled by the server computer.

6. The method of claim 1, further comprising receiving, by the server computer, from a second user an indication of an offer to sell at least one product in the database of products.

7. The method of claim 6, further comprising:
receiving, by the server computer, from the second user an offered product photo corresponding to the offer to sell; and
matching, by the server computer, the offered product photo to a product in the database of products.

8. The method of claim 1, wherein the step of receiving an indication to obtain a product based on an image comprises receiving an identification of a particular region of a larger image.

9. The method of claim 1, wherein the one or more specifications comprise at least one of size, price, color, style, brand, and price, and wherein the one or more specifications are used during the step of searching to select particular products from the database of products as matches to the requested product.

10. An apparatus, comprising:
a memory;
a processor coupled to the memory and configured to perform steps comprising:
receiving, at a server computer, an indication generated by a client computer of a request from a user to obtain a product based on an image and one or more specifications;
searching, by the server computer, a database of products for matches to the requested product based, at least in part, on the received image and the received one or more specifications; and
sending, by the server computer to the client computer, information regarding the matches to the product, wherein the information includes at least one identification of an offer to sell the matched product.

11. The apparatus of claim 10, wherein the step of searching for matches comprises:
identifying, by the server computer, a same or similar image in the database of products based on the received image; and
retrieving, by the server computer, the information from the database based on the identified same or similar image.

12. The apparatus of claim 10, wherein the step of searching for matches comprises:
receiving, by the server computer from a second client computer, an identification of a matched product from a community member and information regarding the matched product, wherein the information regarding the matched product comprises a link to an offer to sell the matched product; and
storing, by the server computer in the database of products, the identification of the matched product and the information regarding the matched product.

13. The apparatus of claim 10, wherein the step of searching for matches comprises executing a software algorithm to identify a matched product by comparing the received image with the database of products.

14. The apparatus of claim 10, wherein the processor is further configured to perform steps comprising:
crawling, by the server computer, webpages of product manufacturers, wherein the webpages comprise product images;
inserting, by the server computer, the product images into the database of products; and
inserting, by the server computer, links to the webpages comprising the inserted product images into the database of products, wherein the links are associated with the product images in the database of products,
wherein the step of sending information regarding the matches to the product comprises sending a link to a webpage crawled by the server computer.

15. The apparatus of claim 10, wherein the processor is further configured to perform steps comprising:
receiving, by the server computer, from a second user an indication of an offer to sell at least one product in the database of products; and
receiving, by the server computer from the client computer, an indication of a request by the user to accept the offer to sell the matched product.

16. A computer readable medium, comprising:
a non-transitory computer readable medium comprising code to perform steps comprising:
receiving, at a server computer, an indication generated by a client computer of a request from a user to obtain a product based on an image and one or more specifications;
searching, by the server computer, a database of products for matches to the requested product based, at least in part, on the received image and the received one or more specifications; and
sending, by the server computer to the client computer, information regarding the matches to the product, wherein the information includes at least one identification of an offer to sell the matched product.

17. The computer readable medium of claim 16, wherein the step of searching for matches comprises:
identifying, by the server computer, a same or similar image in the database of products based on the received image; and
retrieving, by the server computer, the information from the database based on the identified same or similar image.

18. The computer readable medium of claim 16, wherein the step of searching for matches comprises:
receiving, by the server computer from a second client computer, an identification of a matched product from a community member and information regarding the matched product; and
storing, by the server computer in the database of products, the identification of the matched product and the information regarding the matched product.

19. The computer readable medium of claim 16, wherein the step of searching for matches comprises executing a software algorithm to identify a matched product by comparing the received image with the database of products.

20. The computer readable medium of claim 16, wherein the medium further comprises code to perform steps comprising:
crawling, by the server computer, webpages of product manufacturers, wherein the webpages comprise product images;
inserting, by the server computer, the product images into the database of products; and
inserting, by the server computer, links to the webpages comprising the inserted product images into the database of products, wherein the links are associated with the product images in the database of products,
wherein the step of sending information regarding the matches to the product comprises sending a link to a webpage crawled by the server computer.
